(19) United States
(12) Patent Application Publication
(10) Pub. No.: US 2012/0069945 A1
(43) Pub. Date: Mar. 22, 2012

(54) INTERACTIONS OF CHARGED PARTICLES ON SURFACES FOR FUSION AND OTHER APPLICATIONS

(75) Inventor: Nabil M. Lawandy, Saunderstown, RI (US)

(73) Assignee: SOLARIS NANOSCIENCES CORPORATION, Providence, RI (US)

(21) Appl. No.: 13/301,213

(22) Filed: Nov. 21, 2011

Related U.S. Application Data
(63) Continuation-in-part of application No. 12/555,367, filed on Sep. 8, 2009.

(51) Int. Cl. G21B 1/00; G21B 3/00

(52) U.S. Cl. 376/107; 976/DIG. 4

(57) ABSTRACT

A method of generating an energy release reaction including providing a surface or interface formed between a first medium and a second medium. Depositing a plurality of like-charged particles in the first medium adjacent to the surface wherein a potential binding energy between the plurality of like-charged particles and the repulsive force that exists between the like charged particles causes the particles to move until a state of equilibrium is reached. Wherein the movement of the particles over said surface generates dissipation energy. Further wherein the state of equilibrium results in a distance between at least two of the like-charged particles to be sufficiently small to result in reaction of the at least two like-charged particles.

### CROSS-REFERENCE TO RELATED APPLICATIONS

This application is a Continuation-in-Part of and claims priority from U.S. patent application Ser. No. 12/555,367, filed Sep. 8, 2009, which claims priority from earlier Provisional Application No. 61/182,936, filed Jun. 1, 2009.

### BACKGROUND OF THE INVENTION

The present invention relates generally to the interactions of charged particles on surfaces and at interfaces and their collective many-particle, long-range Coulomb interactions. More specifically the present invention relates to the generation of energy from the capture of heat energy that is dissipated as a result of the interaction between those charged particles and an adjacent surface and converted to heat.

Nuclear fusion is a naturally occurring phenomenon in stars, and it is the process responsible for the energy created by our sun. Fusion is the process by which small, low mass nuclei join to form larger nuclei with a final mass that is lower than the sum of the initial nuclear masses resulting in the release energy. Fusion of light nuclei such as hydrogen isotopes was first observed by Oliphant in 1932, and the progression of this process to the cycle of nuclear fusion in stars was later worked out by Hans Bethe.

Attempts to create fusion for military applications began with the Manhattan Project and were successfully demonstrated in 1952. Work has continued since then to harness this process for generating cleaner energy in the form of controlled fusion. This work has met considerable obstacles. Nevertheless, some tokamak-based reactors around the world have demonstrated break-even controlled fusion reactor designs that are expected to eventually deliver as much as ten times the energy needed to heat plasma to the required temperatures for fusion to occur. One such reactor, originally known as the International Thermonuclear Experimental Reactor (ITER), is expected to be operational in 2016.

The enormous energy required to drive nuclear reactions is a consequence of the combination of the extremely short range of the attractive strong force and the natural repulsive force that exists between like charges. The energy required to overcome the repulsive forces between light nuclei at the required distances for fusion to occur is on the order of about 10,000 electron volts (eV) to about 1,000,000 eV. Once these conditions are achieved, an exothermic reaction, which releases several mega-electron volts (MeV) of energy, new nuclei and neutrons, can result in a self-sustaining reaction. For example, the deuterium-tritium (D-T) reaction releases about 17 MeV in the recoil energy of the resultant helium (He) nucleus and the released neutron. Similarly, deuterium-deuterium (D-D) reactions exhibit two equally probable channels of fusion with energy release of about 4 MeV and about 3.7 MeV.

Most processes for producing fusion reactions of light nuclei fall into three major classifications: Hot Fusion, Generally Cold-Locally Hot Fusion, and Locally Cold Fusion. Hot Fusion is based on reaching temperatures in the millions of Kelvin and confining the hot plasma to achieve a significant reaction rate consistent with the well-known Lawson Criterion. Methods such as Magnetic Confinement and Inertial Confinement have been developed to drive such processes. The second class of processes relies on the generation of locally hot regions of space where plasma is in contact with a generally cold environment. In other words, the actual region of interest achieves high temperatures or energies while in contact with matter at low temperatures. Various attempts to observe fusion reactions in such systems have been tested and include accelerator-based systems, the Farnsworth-Hirsch Fusor, Antimatter-initialized Fusion, Pyroelectric Fusion and Sonoluminescence.

Over thirty years ago, Locally Cold Fusion experiments were carried out using muons to catalyze the fusion process at ordinary temperatures. In this process, muons, which are negatively charged particles having a mass that is much greater than that of electrons, are injected into molecular gases with light nuclei such as deuterium. The negatively charged muons collide with and replace the electrons binding the nuclei. The heavier mass results in a bond length that is over two hundred times shorter than the Bohr radii characteristic of bond lengths created by the lighter electrons. This shortened bond length allows the nuclei to be close enough to allow the Strong Force to overtake the repulsive force, resulting in fusion that produces heavier nuclei with the release of energy. Unfortunately, this muon catalyzed fusion is greatly limited by the short 2.2 microsecond lifetime of the muons and the so-called alpha sticking problem, where the muon, instead of replacing an electron, will bind to the created alpha particles and stop catalyzing the reaction.

Twenty years ago, Cold Fusion was reported using electrolysis of heavy water with palladium electrodes. Anomalous excess heat generation and traces of Tritium and Helium in the deuterated electrolyte were also reported. Unfortunately, for two decades, no consistent set of experiments has emerged that confirm a fusion reaction. Further, several theoretical works have shown that the effects of palladium and other metals with similar electronic configurations on the internuclear separation of deuterium nuclei within the metal were insignificant and incapable of producing the measured energy release observed in some experiments.

Given the historic research and experimentation surrounding fusion, it is generally known that once sufficient force is applied to the like charged particles in order to overcome the repulsive force, the strong force will take over resulting in fusion. In this context, it is known that such particles must first be bound in a manner that they can be drawn together using naturally existing forces sufficient to overcome the repulsive force. In this regard, charged particles such as elementary particles or atomic or molecular ions can be bound to surfaces by Coulomb forces. In particular, nuclei or other molecular ions wherein the electron has been displaced will bind to surfaces via an attractive force towards the electrons on the molecules within the surface itself. These forces are known and can, in many cases of geometrical symmetry, be found and calculated using charge imaging methods. The energy levels associated with these forces are found to closely match those found by solving the non-relativistic Schrodinger equation by substituting a potential that the particle experiences generated by a fictitious image charge disposed within the binding surface, wherein such a binding surface may be an extended planar surface or other sympathetic arrangements having spherical or cylindrical geometries.

### BRIEF SUMMARY OF THE INVENTION

In this regard, the present invention provides for a system and method of generating energy through the binding of charged particles to a surface or at specific dielectric interfaces. Further embodiments of the invention include a system and method of energy generation by the movement of charge particles resulting from their being deposited on a surface. Further embodiments of the invention include the fusion of nuclei at temperatures below 10,000K. The generation of energy is achieved by dissipation energy released as the deposited particles move to seek equilibrium relative to one another and the binding surface. Further energy is released from fusion reactions, which result from depositing or creating charged nuclei on a surface or in an interface between a high dielectric constant material, such as a metal or dielectric, and a lower dielectric constant relative to the medium in which the charged nuclei reside. An attractive potential is created between two or more charged particles on the surface of the material with the significantly larger dielectric constant or within the lower dielectric constant material at an interface. This attractive potential has its origin in the electrostatic solutions to Laplace's equation for a charge in front of a dielectric or metal plane or other shapes with curvature and edges. The attractive potential is equally expected as between positive or negatively charged particles such as ions, electrons and muons, and can result in binding of such particles.

Forty years ago it was predicted that electrons could be trapped above metallic and dielectric surfaces by image forces. Single electrons would be expected to exhibit an infinite number of bound image states, which exhibit a Rydberg series similar to hydro genic atoms. This work successfully explained the experimentally observed trapping of electrons above the surface of liquid helium. Since this pioneering work, many such systems have been identified and studied extensively using a variety of realistic crystal potentials and various particle scattering and optical techniques. In addition to planar surfaces, work on clusters, droplets, and carbon nanotubes has also been undertaken.

In general, in one aspect, the invention features a method of generating an energy release reaction including providing a surface or interface formed between a first medium and a second medium, the first medium having a first dielectric constant, ε, and the second medium having a second dielectric constant, εₛ wherein ε and εₛ satisfy the relationship:

$$\frac{( ɛ - {ɛ}_{s} )}{( ɛ + {ɛ}_{s} )} < - \frac{1}{2} ;$$

Depositing a plurality of like-charged particles in the first medium adjacent to the surface wherein a potential binding energy between the plurality of like-charged particles and the repulsive force that exists between the like charged particles causes the particles to move until a state of equilibrium is reached. Wherein the movement of the particles over said surface generates dissipation energy. Further wherein the state of equilibrium results in a distance between at least two of the like-charged particles to be sufficiently small to result in reaction of the at least two like-charged particles. The reaction can be nuclear fusion for nuclei particles and chemical or catalytic for ion particles.

In general, in another aspect, the invention features a method of generating a fusion reaction including providing a surface or interface formed between a first medium and a second medium, the first medium having a first dielectric constant, ε, and the second medium having a second dielectric constant, εₛ wherein ε and εₛ satisfy the relationship above, depositing a plurality of ions with nuclei capable of fusion in the first medium adjacent to the surface; and wherein a potential binding energy between the plurality of ions causes a distance between at least two of the ions to be sufficiently small to result in fusion of the at least two ions. In embodiments, the ions may be atomic ions or molecular ions. The plurality of ions may contain nuclei selected from the group consisting of H, D, T, Li and He.

In a dynamic arrangement the present invention provides for the capture of energy from the behavior of surface catalyzed attraction of like charges. Specifically, on a suitable surface, when the two charges have opposite signs, even though they normally attract at all separations in free space, they will experience a repulsive barrier at a dielectric interface where the particles are bound on the side of the interface having a lower dielectric constant. While the like charged particles will repel one another, it has been found that given a sufficient energy input to catalyze the bound particles, like charges will begin to aggregate with one another. Further, the movement of the particles as they aggregate requires movement of the equivalent image charge within the binding surface causing an energy dissipation that is substantially equal to the attractive energy found in the aggregated groups of like particles. This dissipation energy is released in the form of heat.

It is therefore an object of the present invention to provide a system and method of generating energy through the binding of charged particles to a surface. Further it is an object of the present invention to provide a system and method of energy generation by the movement of charge particles resulting from their being deposited on a surface or created at an interface by excitation of electrons and holes in a semiconductor for example.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1A is a diagram of the interaction between two like charges at an interface between two media in accordance with an embodiment of the invention;

FIG. 1B is a diagram of an energy liberating charge inversion reaction showing a first cluster of particles having the same first charge and a second cluster of particles having the same second charge in accordance with an embodiment of the invention;

FIG. 2 is a graph depicting the attractive potential between two charges in accordance with an embodiment of the invention;

FIG. 3 is a graph depicting the position of minimum separation between like charges when deployed at a dielectric interface in accordance with an embodiment of the invention;

FIG. 4 is a graph depicting the behavior of like charges as they aggregate and reach a state of equilibrium in accordance with an embodiment of the invention; and

FIG. 5 is a graph depicting the energy release differential as a function of the number of charged particles in accordance with an embodiment of the invention.

### DETAILED DESCRIPTION OF THE INVENTION

Now referring to the drawings, there is disclosed a system and method of generating energy through the binding of charged particles to a surface and a method of energy generation by the movement of those charge particles resulting from their being deposited on a surface.

As disclosed in U.S. patent application Ser. No. 12/555,367, incorporated herein by reference, it has been shown that although two like charges such as positively charged deuterium nuclei or two positively charged molecular ions, strongly repel each other in free space, they can attract each other and form a bound state when at the surface of a metal or medium with a higher dielectric constant. The symmetry breaking effect of a surface creates a long range attractive force based on physical principles from Laplace, Maxwell and Lord Kelvin.

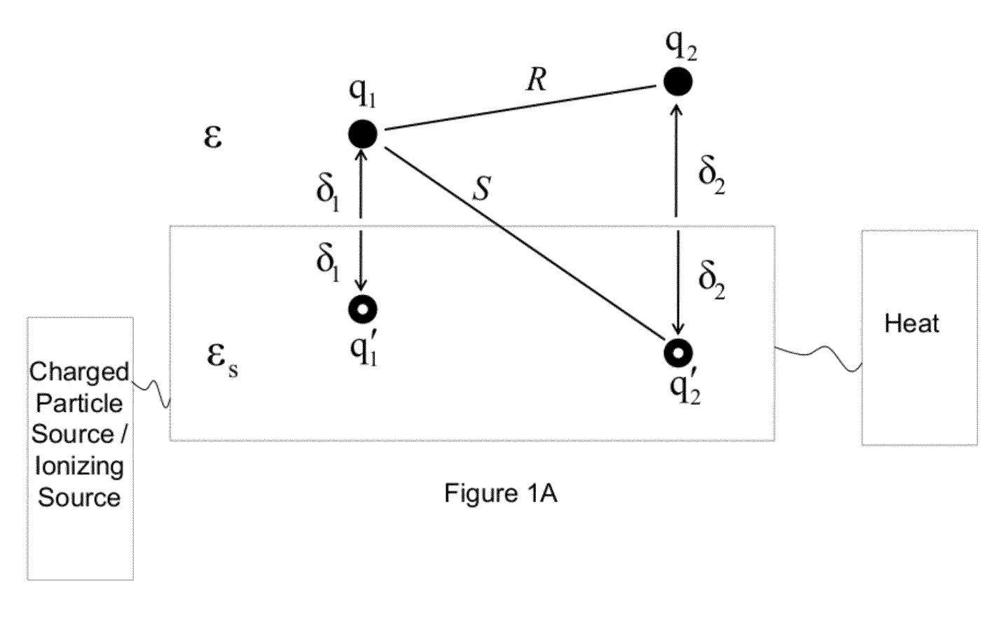

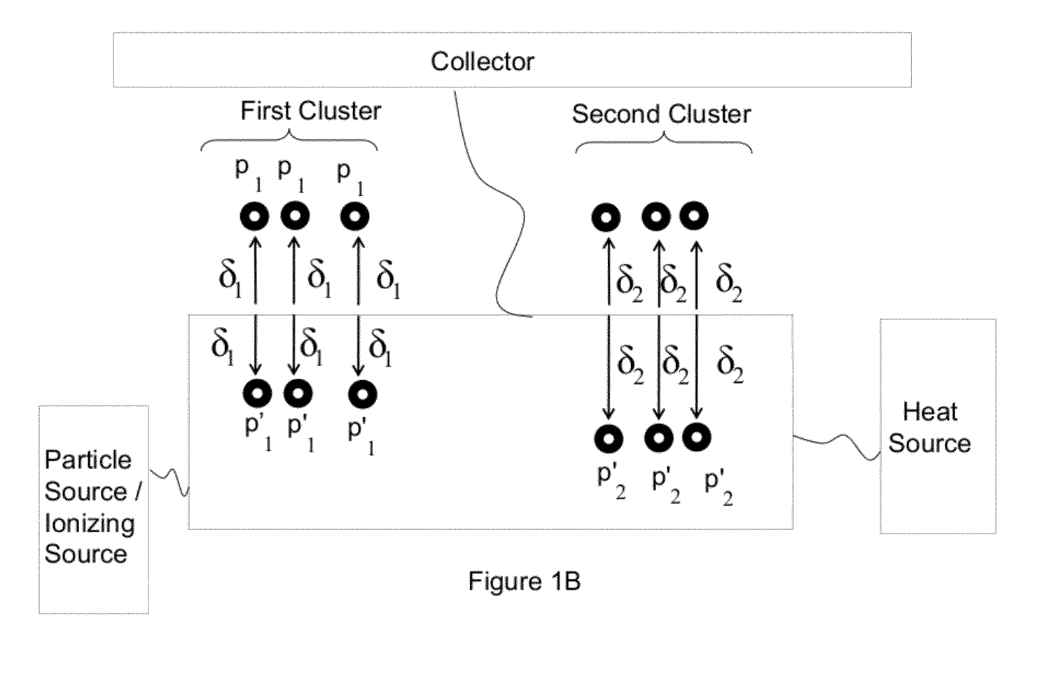

As shown in FIG. 1A, when two like charges q₁ and q₂ are disposed above a dielectric substrate, the potential energy between the charges is due to a combination of the actual charges repelling each other resulting in a separation R and the attractive interaction of the charges interacting with their own image charges q′₁ and q′₂ within the dielectric substrate as well as the other charge's image. When two like charges, whether they are electrons, positrons, ions, muons, or deuterium nuclei are bound by image charges to a surface, as shown in FIG. 1A, the energy governing their relative interaction is given by (δ₁=δ₂=δ):

$$U = \frac{( {Z}_{1} e ) ( {Z}_{2} e )}{4 πɛ} ( \frac{1}{R} + \frac{2 β}{S} ) \qquad ( 1 )$$

Where q₁=Z₁e and q₂=Z₂e are the real charges and

$$β = \frac{[ ɛ - {ɛ}_{s} ]}{[ ɛ + {ɛ}_{s} ]} .$$

In the limit that both charges are at the same height δ, above the ideal interface, the potential exhibits a local minimum at a charge separation given by:

$${R}_{min}^{2} = \frac{4 {δ}^{2}}{{( 2 β )}^{\frac{2}{3}} - 1}$$

Since the particle's own image charge moves with it, this portion of the potential is an additive constant independent of the separation between the charges. It has been demonstrated that wherein the relationship between a first medium and a second medium, the first medium having a first dielectric constant, ε, and the second medium having a second dielectric constant, εₛ wherein ε and εₛ satisfy the relationship:

$$\frac{( ɛ - {ɛ}_{s} )}{( ɛ + {ɛ}_{s} )} < - \frac{1}{2} ;$$

a bound state will occur such that the potential between the two like charges results in a bound two-dimensional state on a high dielectric constant surface. In such a bound state, depositing a plurality of like-charged particles in the first medium adjacent to the surface, the potential binding energy between the plurality of like-charged particles causes a distance between at least two of the like-charged particles to be sufficiently small to result in reaction of the at least two like-charged particles. The reaction can be nuclear fusion for nuclei particles and chemical or catalytic for ion particles.

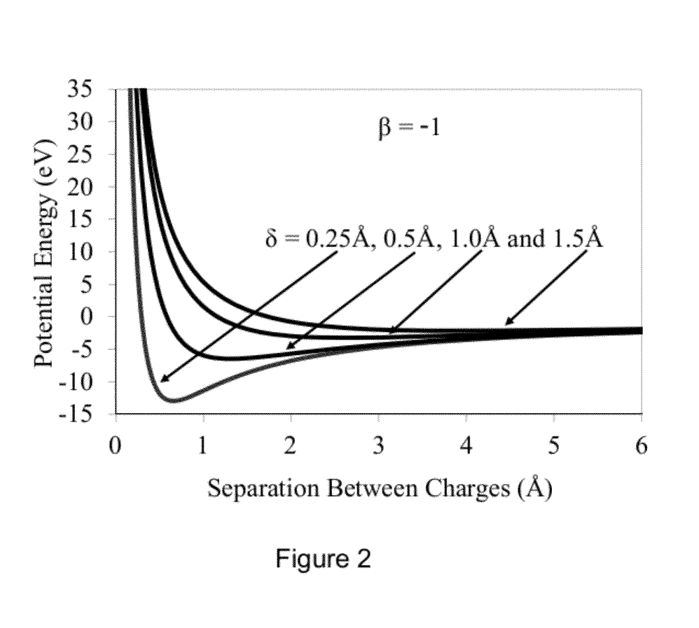

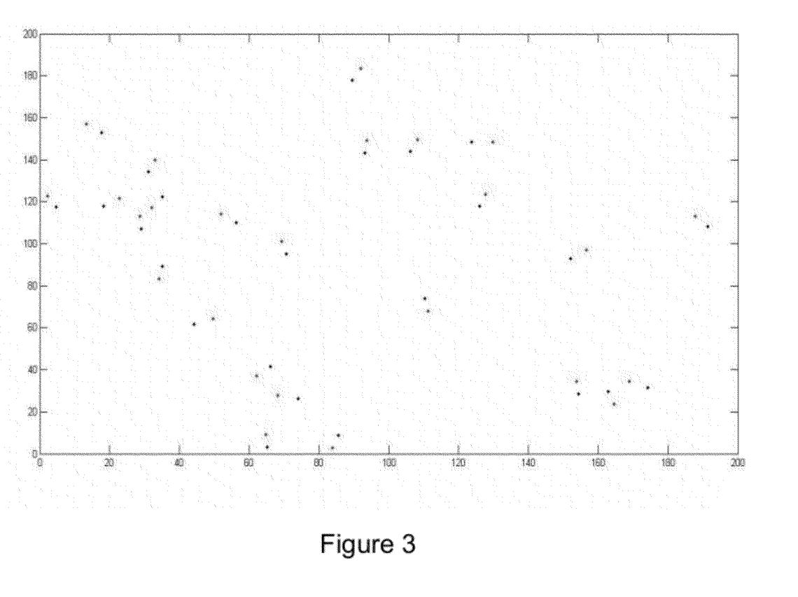

Turning to FIGS. 2 and 3, of particular interest in one embodiment of the present invention is the creation of a dynamic system in order to capture the dissipation energy as the dynamic system seeks equilibrium. In this embodiment, particles are deployed at the dielectric interface before they are ionized. Ionization energy is input to the system to cause the negatively and positively charged particles to separate from one another. It is of note that as shown in FIG. 2, as sufficient ionization energy is input to the system, the negatively and positively charged particles will separate such that a bound state between the particles and the higher dielectric surface will occur such that the particles will no longer seek to recombine with the oppositely charged pairs. In other words, while two charges of opposite sign normally attract at all separations in free space, as ionization energy is entered onto the system, the surface catalyzed binding of like charges overcomes the attraction. Further the like charged particles on the low dielectric constant side of a dielectric interface experience a repulsive barrier as between themselves. However, as can be seen in FIG. 2, the relationship between separation distance and potential energy which indicates an energy barrier as between oppositely charged particles on such an interface, instead inverts and become a well in the case of two like charges. In the case of hydrogen for example, an input of 13.6 eV will result in ionization while further energy at an input level of 15 eV will cause the particles to cross the barrier threshold such that the electrons and nuclei will not return to one another but instead seek to cluster into like groups.

In a system such as depicted in FIG. 1B, the attractive and repulsive forces at a dielectric interface separate opposite charges and coalesce like charges after the input of ionization energy of sufficient potential. As shown in FIG. 1B, particles p₁ having like charges and being bound to the dielectric interface by their image charges p′₁ are clustered with other particles p₁ having like charges while another group of particles p₂ having like charges and being bound to the dielectric interface by their image charges p′₂ cluster in another region apart from the first cluster. As shown in FIG. 1A and FIG. 1B thermal energy can be used to heat the substrate from a heat source which can be directly connected or in optical communication with the substrate or surface. A particle, ion source, or ionizing source (such as an electromagnetic radiation source) can also be directly connected or in optical communication with the substrate as shown. A collector, as shown in FIGS. 1A and 1B, can be used to receive thermal energy released (as will be discussed in more detail below) during the reactions from various phenomena such as Ohmic dissipation. The collector can be in optical communication or directly connected to the surface or substrate as shown.

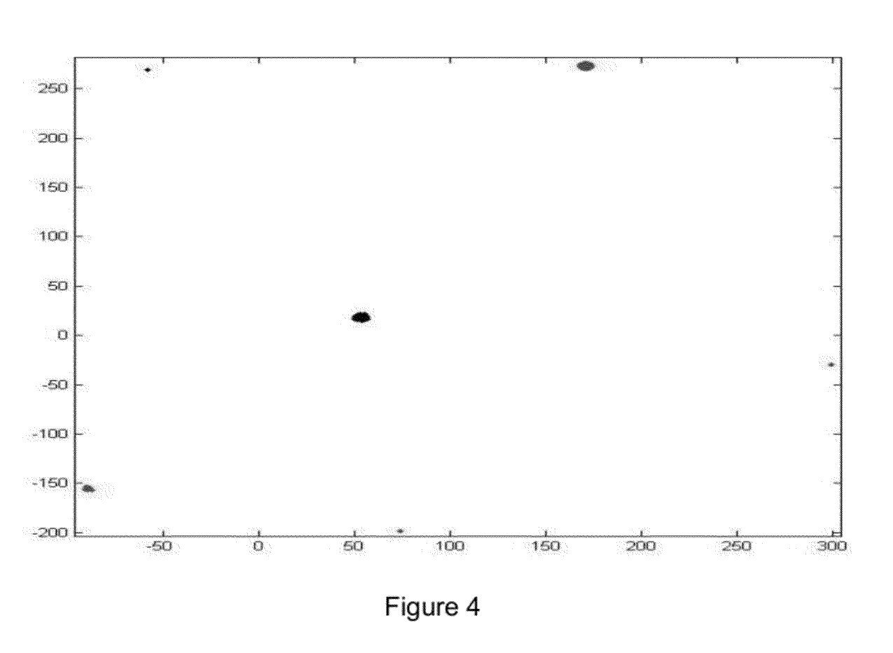

Now viewing FIGS. 3 and 4 in conjunction it can be seen as predicted that once energized and bound to the dielectric interface the particles move in the material having the smaller dielectric constant. FIG. 3 depicts an example of an initial distribution just after ionization. FIG. 4 depicts the final distribution after the charges have moved on the surface. Such movement of the particles as they cluster with other like charges necessarily also requires movement of the image charge located in the higher dielectric material that binds the particles to the interface. It is the dynamic process of the particle and image charge movement that is of particular interest. The dissipation of energy during the movement of the particles towards the equilibrium state depicted at FIG. 4 must all go into heating of the binding surface. The frictional dissipation force Fₓ for each singular particle having a charge (q) moving at a velocity (V) and over a distance (d) spaced (δ) above the dielectric interface between a first medium having a first dielectric constant ε, and a second medium having a second dielectric constant, εₛ having

$$β = \frac{[ ɛ - {ɛ}_{s} ]}{[ ɛ + {ɛ}_{s} ]}$$

is represented as follows:

$${F}_{x} = \text{?}$$

$$\text{?} \text{indicates text missing or illegible when filed}$$

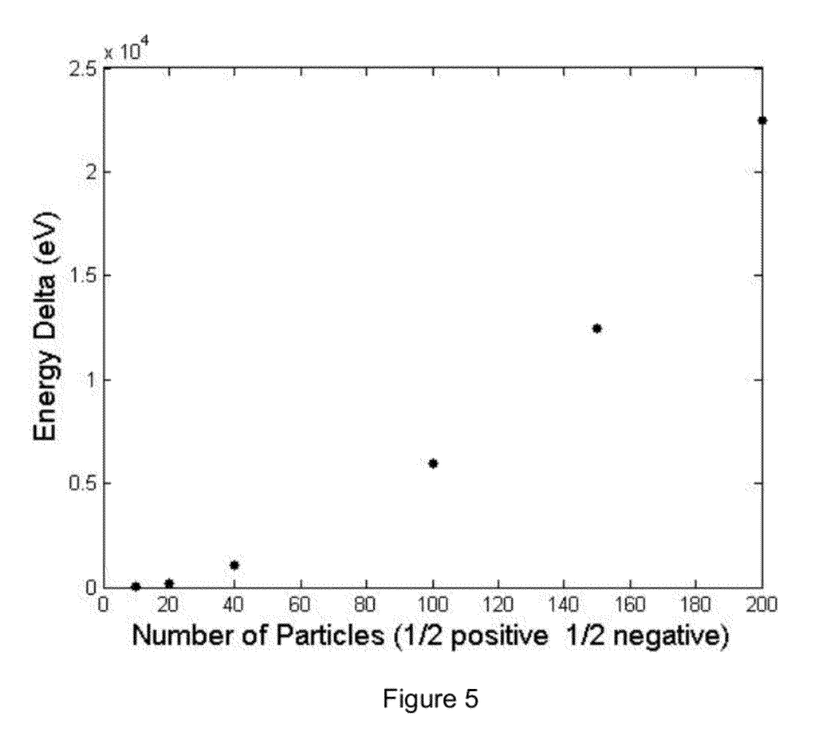

Given the above dissipation of energy based on a singular particle, it can be appreciated that when 2N charges (N negative and N positive) are created by the ionization of N neutral particles with enough energy to separate the ionization products by the barrier height, the charges proceed through dynamic movement to reorganize into positive and negative clusters. During the dynamic process the movement of each particle serves to dissipate energy. The reorganization is significant and scales in a non-linear fashion based on the number of particles, N. The thermal energy dissipated is the difference between the initial potential energy of the charge distribution with images and the final charge distribution of the charges where positive clusters and negative clusters and formed and remain separate. The power that is generated is a function of the time the process takes to reach equilibrium. FIG. 5 shows the energy difference in eV (electron volts) as a function of N for neutral pairs which are initially far apart. As can be seen the reaction produces excess energy in the form of dissipated heat. The excess energy as depicted in FIG. 5 for 100 neutral particles in the case of hydrogen for example is the difference between the energy required to cross the barrier on the order of 15 eV per particle times 100 particles or 1.5×10³ eV and the released energy of about 2.25×10⁴ eV. Giving an energy generation potential on the order of 2.1×10⁴ eV.

Ionization of the neutral pair atoms or molecules can be initiated by electric fields, light, heat or any other means including a catalytic surface such as gold, palladium, nickel or any other catalyst support system. Further, the surface may be a single macroscopic material or a nano-porous or nano-particle composite.

Embodiments of the invention are applicable to one charge species (positive or negative) created on a surface. Such an embodiment is created on the surface of a low work function photocathode material, for example (S1 photocathode). Since mobility on the surface is desirable, heating the surface to which the charges are bound is performed in some embodiments. Thus, as shown, in some embodiments, a heat source can be used as part of the system (see FIGS. 1A and 1B) to facilitate particle mobility and surface state conductivity within certain regimes.

In one exemplary embodiment of the present invention the interface may be created as a semiconductor interface between a 2d layer of gallium arsenide (GaAs) particles having a dielectric constant of 12.9 and a gold (Au) substrate forming an interface having a β of nearly −1. The surface is exposed to energy having a specific wavelength. More particularly, the interface is exposed to energy having a wavelength that is sufficiently above the band gap of the material such that it causes electron/hole pairs to form and cross the recombination barrier disclosed above. In this embodiment, provided a majority of energized electron/hole pairs cross the recombination barrier, the like particles will move in a dynamic fashion wherein like particles are clustered and the resulting dissipation energy from the movement will be released as heat.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method of initiating a charge-particle-based reaction comprising:
providing an interface formed between a first medium and a second medium, the first medium having a first dielectric constant, ε, and the second medium having a second dielectric constant, εₛ, wherein ε and εₛ satisfy the relationship:
$$\frac{( ɛ - {ɛ}_{s} )}{( ɛ + {ɛ}_{s} )} < - \frac{1}{2} ;$$
depositing a plurality of particles in the first medium adjacent the interface;
introducing sufficient energy to separate the particles by a barrier height resulting in a dynamic system wherein positive particles and negative particles seek to move into clusters with other like charged particles; and
capturing energy generated by the movement of said particles.

2. The method of claim 1 wherein movement of said charged particles to said clusters causes Ohmic dissipation energy.

3. The method of claim 2 further comprising the step of heating at least one of first medium or the second medium through the dissipation of the movement of said charged particles.

4. The method of claim 1 further comprising the step of heating at least one of first medium or the second medium through the dissipation of the movement of said charged particles.

5. The method of claim 1 wherein particle separation is initiated by the introduction of energy selected from the group consisting of: electric fields, light and heat.

6. The method of claim 1 wherein particle separation is initiated by a catalytic surface.

7. The method of claim 1, wherein said particles are neutral particles, said introduction of energy step further comprising ionizing said neutral particles to create ionization products.

8. The method of claim 1, wherein said particles are particles within a semiconductor interface, said introduction of energy step further comprising the excitation of electrons to form electron/hole pairs that cross a recombination barrier.

9. The method of claim 8, wherein said introduction of energy is the introduction of above bandgap light.

10. A method of generating thermal energy:
providing an interface formed between a first medium and a second medium, the first medium having a first dielectric constant, ε, and the second medium having a second dielectric constant, εₛ, wherein ε and εₛ satisfy the relationship:
$$\frac{( ɛ - {ɛ}_{s} )}{( ɛ + {ɛ}_{s} )} < - \frac{1}{2}$$
depositing a plurality of neutral particles in the first medium adjacent to the interface;
ionizing the plurality of neutral particles with a sufficient energy to separate the ionization products by a barrier height resulting in a dynamic system wherein positive ions and negative ions seek to move into clusters said movement causing thermal energy dissipation and heating of the second medium; and
capturing the thermal dissipation energy.

11. The method of claim 10 wherein one of the first medium or the second medium is a low work function photocathode material.

12. A thermal energy generator comprising:
a first material having a first dielectric constant;
a second material having a second dielectric constant that is smaller than the first dielectric constant;
a surface bounded by a junction of the first material and a second material;
a heat source in thermal communication with the surface; and
a collector in thermal communication with the surface and configured to receive thermal energy released from a reaction occurring at least in part on the surface, wherein the surface separates oppositely charged particles and coalesces like charged particles.

13. The thermal energy generator of claim 12, wherein the reaction is a charge inversion reaction that releases heat in excess of an amount of input energy.

14. The thermal energy generator of claim 12, wherein said particles are particles within a semiconductor interface, wherein separating said particles comprises the excitation of electrons to form electron/hole pairs that cross a recombination barrier.

15. The thermal energy generator of claim 13, wherein said electron/hole pairs are formed by the introduction of above bandgap light.
